(19) United States
(12) Patent Application Publication
(10) Pub. No.: US 2008/0222137 A1
(43) Pub. Date: Sep. 11, 2008

(54) Information analyzing device, and computer readable recording medium

(75) Inventors: Hiroshi Okamoto, Kanagawa (JP); Yukihiro Tsuboshita, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/907,604

(22) Filed: Oct. 15, 2007

(30) Foreign Application Priority Data
Mar. 7, 2007 (JP) 2007-056723

(51) Int. Cl. G06F 17/30

(52) U.S. Cl. 707/5; 707/E17.001

(57) ABSTRACT

For information about a plurality of objects with respect to which directed relation and relation weight are set, a virtual bidirectional relation is set between objects in a pair, and a weight for the virtual relation is set different from that of the predetermined relation. Then, a process to produce predetermined information about the object is carried out based on the relation.

### CROSS-REFERENCE TO A RELATED APPLICATION

This application is based on and claims priority under 35 U.S.C. 119 from Japanese Patent Application No. 2007-056723 filed on Mar. 7, 2007.

### BACKGROUND

1. Technical Field

The present invention relates to an information analyzing device and a computer readable recording medium.

2. Related Art

For data groups, such as document groups or the like, for example, there may be at least a mutual citation, such as citation in patents or academic theses, is defined.

As to the citation relation among the documents, it is always the case that a document issued later in time cites a document issued earlier in time. That is, this relation is always unidirectional. Therefore, when a data ranking process is carried out according to the relation, using a method such as spreading activation, virtual random walk, or the like, the activation amount and the random walk always flow in the determined direction. That is, for example, a document prepared later in time among the accumulated documents has fewer documents which cite that document, and thus cannot receive an activation amount. As described above, due to the direction of the relation (for example, time direction), there results a lack of fairness among the respective data.

### SUMMARY

According to an aspect of the invention, there is provided an information analyzing device having an acquisition unit that acquires information about multiple objects with respect to which at least one directed relation and a relation weight are set; a relation setting unit that sets virtual bidirectional relations between the objects in pairs, utilizing the acquired information; a weight setting unit that sets a weight as to the virtual bidirectional relation, the weight being different from the relation weight set in advance; and a process execution unit that carries out a process to produce predetermined information about the object based on the relation.

### BRIEF DESCRIPTION OF THE DRAWINGS

An exemplary embodiment of the present invention will be described in detail based on the following figures, wherein:

FIG. 1 is a block diagram showing a structure of an information analyzing device according to an exemplary embodiment of the present invention;

FIG. 2 is a block diagram showing functions of the controller of the information analyzing device according to the exemplary embodiment of the present invention; and

FIG. 3 is a diagram explaining an example operation of the information analyzing device according to the exemplary embodiment of the present invention.

### DETAILED DESCRIPTION

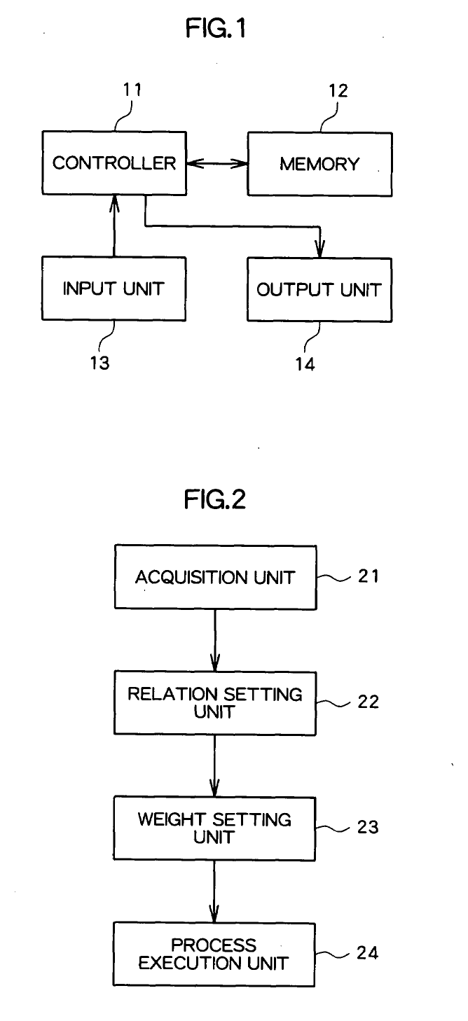

An information analyzing device according to an exemplary embodiment of the present invention is realized by means of software, using a computer or the like. As shown as an example in FIG. 1, an information analyzing device in this exemplary embodiment has a controller 11, a memory 12, an input unit 13, and an output unit 14.

The controller 11 is a program control device, such as a CPU or the like, and operates according to a program stored in the memory 12. The controller 11 in this exemplary embodiment acquires, via the input unit 13, for example, from a database (not shown) or the like, information about multiple objects with respect to which directed relation and relation weight are set originally in advance. When it is determined, based on the acquired information, that the directed relation which is set with respect to a pair of objects among the multiple objects is not bidirectional, a virtual relation is set with respect to the pair of objects, to thereby set at least bidirectional relations. In the above, weight for the virtual relations are set so as to be different from the relation weight for the unidirectional relations which are the base of the virtual relations. Then, a process to produce predetermined information about the object is carried out based on the relation set originally and virtually. Specific content of the process by the controller 11 will be described later in detail.

The memory 12 has a memory element, such as a RAM (Random Access Memory), a hard disk, or the like. The memory 12 stores a program to be executed by the controller 11. The program may be presented being stored in various computer readable recording media, such as an optical disc medium, a magnetic medium, and so forth, and copied to, and stored in, the memory 12. The memory 12 operates as a work memory of the controller 11.

The input unit 13 may be a communication unit for receiving information from a database or the like, for example. The input unit 13 may include a keyboard, a mouse, or the like, for receiving a user instruction operation. The input unit 13 outputs the received information to the controller 11.

According to an instruction from the controller 11, the output unit 14 outputs information to the outside. For example, the output unit 14 may have a display or the like, and output information by displaying. Alternatively, the output unit 14 may have a printer or the like, and output information by printing.

In the following, the specific content of a process to be carried out by the controller 11 will be described. As shown in FIG. 2, the controller 11 has, in terms of function, an acquisition unit 21, a relation setting unit 22, a weight setting unit 23, and a process execution unit 24. In the following, it is assumed for the purpose of explanation that the object to be analyzed by the information analyzing device in this exemplary embodiment is a document set, and that citation relations are set as directed relations with respect to each document. In this case, no document cites a document issued later than the preparation date thereof. Therefore, the citation relations are always unidirectional in terms of time.

In the following, a matrix A indicative of a citation network is defined as follows as information describing the citation relations. That is, this matrix A is defined as a matrix N×N, N being the number of documents to be processed. The documents are numbered as 1, 2, 3 . . . according to the order of production.

The relation in which the document j cites the document i is expressed as

Aij=w

in which w is a value other than 0 and the value of a weight (relation weight) for the citation relation of the documents. As an example,

w=1

may be uniformly defined. The relation in which the document j does not cite the document i is expressed as

Aij=0.

As no document cites itself,

Aii=0

is determined.

Using the matrix A, the number (an out-link number) kout (j) of documents which the document j cites (that is, cited by the document j) is expressed as

$${\sum }_{i = 1}^{N} {A}_{ij} = {k}_{out} ( j )$$

The number (in-link number) kin (j) of documents which cite the document j (that is, the document j is cited) is expressed as

$${\sum }_{i = 1}^{N} {A}_{ji} = {k}_{in} ( j )$$

The controller 11 produces the matrix A while excluding documents without citation relations from the documents to be analyzed. Therefore, there is no document having the out-link number and in-link number being both 0. That is,

kₒᵤₜ(j)≠0

or

kₒᵤₜ(j)=0 and kᵢₙ(j)≠0

The acquisition unit 21 of the controller 11 finds a combination of i and j from the matrix, the combination enabling Aij≠0 and Aji=0. That is, a combination relevant to a pair of objects with respect to which unidirectional relation is set is extracted. As described above, as the object to be analyzed is a document set and a process based on the citation relations are carried out in this example, when a document j cites another document i, the document j is never cited by the document i. That is, when

Aij≠0

is held,

Aji=0

is always held.

As for the combination of the extracted i and j (combination of i and j which enables Aij≠0 and Aji=0), the relation setting unit 22 of the controller 11 virtually sets a link from i to j, which actually does not exist, to thereby ensure a bidirectional relation between i and j.

The weight setting unit 23 of the controller 11 sets a weight for each of the virtual relation as follows. When the out-link number of the document i is other than 0 (citing other document), then correction is made such that the total weight of the document cited by the document i becomes a predetermined value m (with m>0), where weight of the document cited includes weight of the citation relation which is set for virtual bidirectional relation. That is,

$$\overline{{A}_{ij}} = {A}_{ij} + \frac{m}{{k}_{out} ( i )} {A}_{ji} \\ where i \neq j \qquad ( 1 )$$

When the out-link number of the document i is 0 (citing no other document) (in this case, the in-link number is not 0),

A̅ᵢ̅ⱼ̅=Aᵢⱼ where i≠j (2)

is determined to produce a corrected matrix A. Here, the value of the corrected Aij is expressed with a bar as

A̅ᵢ̅ⱼ̅

The process execution unit 24 of the controller 11 calculates the ranks of the respective documents based on, for example, the matrix A corrected as described above, using one of the dynamic methods, such as a spreading activation, continuous fixed point attractor dynamism, virtual random walk, or the like. Also, manipulation employed in the equation (1) so as to attain the total weight of the cited documents being a predetermined value m is a correction of the out-link number to be m. This manipulation is made relative to any document j. Where each of the documents actually cites various numbers of other documents, the above-described manipulation corresponds to normalization of the number uniformly to the number m. In the above, in calculation of the rank of each document, using a dynamic method, such as the spreading activation, continuous fixed point attractor dynamism, virtual random walk, or the like, the rank of each document is determined mainly based on how much that document is cited, rather than the number of other documents that document cites (that is, the larger number does not necessarily mean a higher value and the smaller number does not necessarily mean a lower value).

It should be noted that the process for setting the weight can be applied in a case other than the case in which “j cites i, but not vice versa”.

It should be noted that a case is described in the above in which a virtual relation is set with respect to a pair of documents which originally have unidirectional relation, the virtual relation directed opposite from the direction of the originally set relation, but this exemplary embodiment is not limited to this case. That is, the relation setting unit 22 may set a virtual relation, for each document, with respect to all other documents. In this case, regardless of whether or not any relation is already set, a virtual relation may be set. That is, in this case, the value of

$${A}_{ij}^{*} = {A}_{ij} + \frac{μ}{N - 1} w$$

$$where i \neq j$$

is calculated, using the component Aij of the matrix A, and then, using the calculated value, the component Aij of the matrix A is corrected to be

$$\overline{{A}_{ij}} = {A}_{ij}^{*} + \frac{m}{{k}_{out} ( i ) + μ} {A}_{ji}^{*}$$

Further, in the case of the equation (2), the weight setting unit 23 may set a weight, using the virtually set out-link value (same as the in-link value), such that the sum of the virtually set out-link weights becomes “m·w”. That is, instead of the equation (2), the controller 11 may determine that the correction value of the component Aij of the matrix A with the out-link number of the document i being 0 (not citing other document) is

$$\overline{{A}_{ij}} = {A}_{ij} + \frac{m}{{k}_{i n} ( i )} {A}_{ij}$$

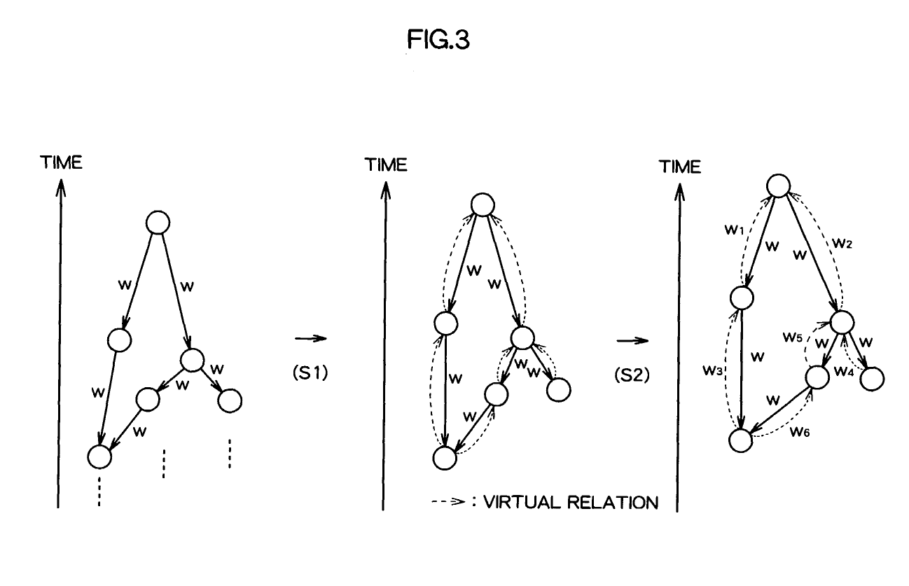

According to the information analyzing device in this exemplary embodiment, as conceptually shown in FIG. 3, based on the citation relation among the weights w determined in advance with respect to the respective documents (indicated by a circle in FIG. 3), citation relation in an opposite direction is virtually determined (S1). Thereafter, the information analyzing device in this exemplary embodiment sets a weight for the virtually determined citation relation such that the sum of the entire weights of the out-link becomes “m·w” (S2). The analyzing device in this exemplary embodiment carries out a dynamic ranking process, such as spreading activation or the like, for the network of the documents with respect to which citation relation is set as described above, to thereby rank the document.

It should be noted that, although a document is ranked in the above, this is not an exclusive example. For example, the process performed by the information analyzing device in this exemplary embodiment can be applied to information about any object with respect to which directed relation is set, such as information about people with respect to whom a contact network is determined.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information analyzing device, comprising:
an acquisition unit that acquires information about a plurality of objects with respect to which at least one directed relation and a relation weight are set;
a relation setting unit that sets virtual bidirectional relation between the objects in pair, utilizing the acquired information;
a weight setting unit that sets a weight for the virtual bidirectional relation, the weight being different from the relation weight set in advance; and
a process execution unit that carries out a process to produce predetermined information about the object based on the relation.

2. The information analyzing device, comprising:
an acquisition unit that acquires information about a plurality of objects with respect to which at least one directed relation and a relation weight are set;
a relation setting unit that sets, when the directed relation is set with respect to objects in a pair contained in the plurality of objects is unidirectional, bidirectional relation by setting a virtual relation in a direction opposite from the directed relation already set, utilizing the acquired information;
a weight setting unit that sets a weight as to the virtual relation, the weight being different from the unidirectional relation weight which is a base of the virtual relation; and
a process execution unit that carries out a process to produce predetermined information about the object based on the relation.

3. The information analyzing device, comprising:
an acquisition unit that acquires information about a plurality of documents with respect to which at least one directed relation of citation and a relation weight are set;
a relation setting unit that sets virtual bidirectional relation citation between documents in a pair, utilizing the acquired information;
a weight setting unit that sets a weight for the virtual relation of citation, the weight being different from the relation weight set in advance; and
a process execution unit that carries out a process to produce predetermined information about the document based on the relation.

4. A computer readable recording medium storing a program for causing a computer to:
acquire information about a plurality of objects with respect to which directed relation and a relation weight are set;
set virtual bidirectional relation between objects in a pair, utilizing the acquired information;
set a weight for the virtual relation, the weight being different from the relation weight set in advance; and
carry out a process to produce predetermined information about the object based on the relation.

5. A computer data signal embodied in a carrier wave for enabling a computer to perform a process comprising:
acquiring information about a plurality of objects with respect to which directed relation and a relation weight are set;
setting virtual bidirectional relation between objects in a pair, utilizing the acquired information;
setting a weight for the virtual relation, the weight being different from the relation weight set in advance; and
carrying out a process to produce predetermined information about the object based on the relation.
